(19) United States
(12) Patent Application Publication
(10) Pub. No.: US 2024/0362513 A1
(43) Pub. Date: Oct. 31, 2024

(54) Quantum Trip Wire System Based on Payload Vector

(71) Applicant: Bank of America Corporation, Charlotte, NC (US)

(72) Inventors: Swarn Deep, Dwarka (IN); Kamal Joshi, Ghaziabad (IN); Venugopal Ramini, Vanasthali Puram (IN); Rinki Aggarwal, Telangana (IN); Yogeshkumar Sukumar, Newark, DE (US); Partha Dhar, Chester Springs, PA (US); Ravi Kiran Hukmani, Kondapur (IN)

(21) Appl. No.: 18/139,487

(22) Filed: Apr. 26, 2023

(51) Int. Cl. G06N 10/20; G06N 10/80

(52) U.S. Cl. CPC G06N 10/20; G06N 10/80

(57) ABSTRACT

A quantum computing platform may receive application programming interface (API) information. The quantum computing platform may convert the API information to a two qubit state. The quantum computing platform may apply, to the converted API information, a CNOT gate, which may produce a trip wire flag value of zero or one. Based on identifying a trip wire flag value of zero, the quantum computing platform may activate a quantum trip wire, which may cause at least a portion of the API information to be routed to an overflow processing system.

### BACKGROUND

In some instances, computing platforms may become overwhelmed when there is a surge of incoming data, requests, and/or other information for a certain service or group of services. This may, in some instances, result in system latency, denial of service, system crash/hard down situations, and/or other system inefficiencies. It may be especially difficult to prevent such overloading of computing platforms when the incoming data, requests, and/or information surge in unpredictable ways. Some systems may have minimal (if any) tolerance for downtime. In these instances, any crash or hard down situation may result in adverse customer impact, revenue loss, and/or reputation impact for the corresponding organization. Accordingly, it may be important to develop methods for preventing such overload, regardless of the predictability of incoming data.

### SUMMARY OF THE INVENTION

Aspects of the disclosure provide effective, efficient, scalable, and convenient technical solutions that address and overcome the technical problems associated with load management in high volume, low downtime systems. In accordance with one or more embodiments of the disclosure, a quantum computing platform comprising at least one processor, a communication interface, and memory storing computer-readable instructions may receive application programming interface (API) information. The quantum computing platform may convert the API information to a two quantum bit (qubit) state. The quantum computing platform may apply, to the converted API information, a controlled-not (CNOT) gate, which may produce a trip wire flag value of zero or one. Based on identifying a trip wire flag value of zero, the quantum computing platform may activate a quantum trip wire, which may cause at least a portion of the API information to be routed to an overflow processing system.

In one or more instances, the API information may be a plurality of different information streams, and activating the quantum trip wire may include activating, for a single information stream of the plurality of different information streams, the quantum trip wire. In one or more instances, the API information may be one or more of: consumer API data, small business API data, merchant API data, payment API data, or digital services API data.

In one or more examples, converting the API information to the two qubit state may include rotating, around a Z axis and using a quantum gate, a state vector representative of: 1) an incoming trip wire webservice volume corresponding to the API information and represented by an X axis, and 2) a trip wire status, indicating whether or not the quantum trip wire has been activated, represented by a Y axis, wherein the Z axis is representative of the trip wire flag value. In one or more examples, the overflow processing system may be an overflow queuing system, configured to store the portion of the API information.

In one or more instances, the quantum computing platform may continue monitoring the trip wire flag value. Based on identifying that the trip wire flag value has changed to one (1), the computing platform may redirect the portion of the API information from the overflow processing system to the quantum computing platform.

In one or more examples, the overflow processing system may be configured to process the portion of the API information as an alternative to the quantum computing platform. In one or more examples, the computing platform may continue monitoring the trip wire flag value. Based on identifying that the trip wire flag value has changed to one (1), the quantum computing platform may cease redirection of the portion of the API information to the overflow processing system. In one or more examples, based on identifying a value of one (1), the quantum computing platform may process the API information, which may include processing one or more requests corresponding to the API information.

### BRIEF DESCRIPTION OF DRAWINGS

The present disclosure is illustrated by way of example and not limited in the accompanying figures in which like reference numerals indicate similar elements and in which:

FIGS. 1A-1B depict an illustrative computing environment for dynamically activating a quantum trip wire based on payload vectors in accordance with one or more example embodiments.

FIGS. 2A-2C depict an illustrative event sequence for dynamically activating a quantum trip wire based on payload vectors in accordance with one or more example embodiments.

FIG. 3 depicts an illustrative method for dynamically activating a quantum trip wire based on payload vectors in accordance with one or more example embodiments.

FIG. 4 depicts an illustrative diagram related to dynamically activating a quantum trip wire based on payload vectors e in accordance with one or more example embodiments.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. In some instances other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

The following description relates to using quantum computing to dynamically activate a trip wire system based on payload vectors. For example, a platform may become overwhelmed when there is a surge in transaction volume for a certain service or group of services. This may lead to latency, denial of service, or even a system crash/hard down situation. For platforms that have a requirement to be always available (e.g., zero downtime) and/or have minimal tolerance for downtime, this may result in adverse customer impact, revenue loss, and reputation impact for a financial institution.

Accordingly, described herein is a quantum trip wire system payload system that is based on vector processing logic having a bloch sphere plane that demonstrates the state of one qubit. Input parameters may include an incoming trip wire webservice volume. A combination of a unitary and Hadamard quantum gate may be applied with a state or rotation lying in the XZ plane with a bloch-sphere angle θ.

In these instances, the X axis may represent an incoming trip wire webservice volume. The Y axis may represent a trip wire status. The Z axis may represent a trip wire flag (V=1 & V=0).

To trigger trip wire flip logic, an operator may be applied to the qubit to rotate the qubit from XZ into the XY plane. This trip wire may use a quantum based CNOT flip gate algorithm.

Two-qubit quantum circuits may rotate the state vector of an input qubit. The inputs to the quantum circuit may include a first qubit, referred to as the control qubit. The state of the control qubit may be measured by a measurement operator in fetching a desired trip wire flag of zero or one. The inputs may also include a second qubit, referred to as the subject qubit, which may have an arbitrary state representative of the trip wire status.

This trip wire system may be used to protect any platform from incoming high surges of transactions. The system may be particularly applicable to platforms that might not realistically predict the incoming transaction volume, but have a requirement for high availability (e.g., credit underwriting systems, trading platforms, digital sales platforms, or the like).

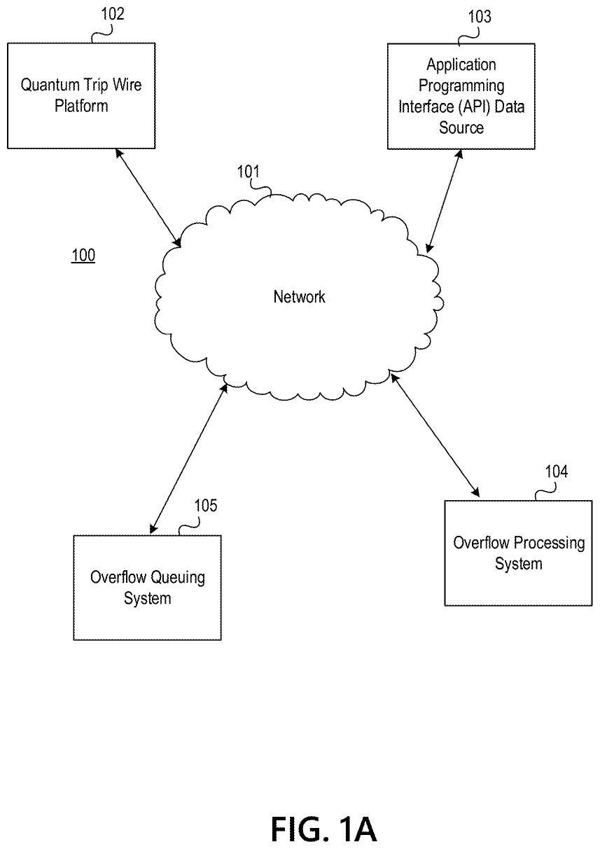

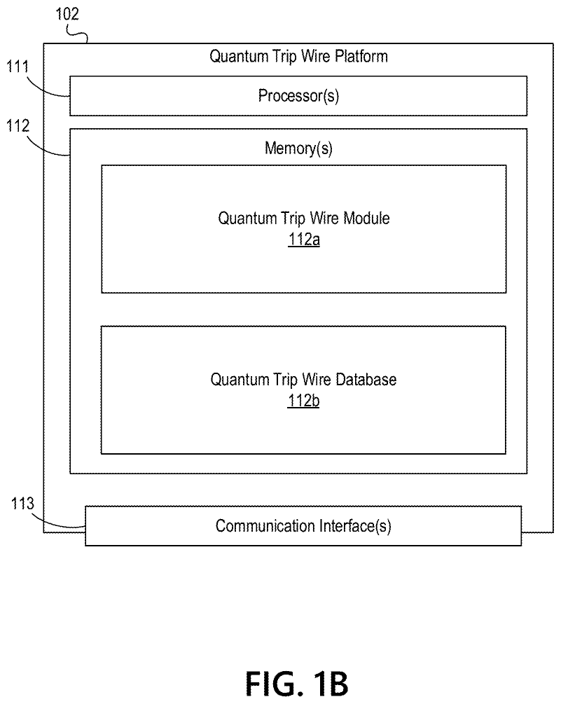

FIGS. 1A-1B depict an illustrative computing environment for dynamically activating a quantum trip wire based on payload vectors in accordance with one or more example embodiments. Referring to FIG. 1A, computing environment 100 may include one or more computer systems. For example, computing environment 100 may include a quantum trip wire platform 102, application programming interface (API) data source 103, overflow processing system 104, and overflow queuing system 105.

Quantum trip wire platform 102 may include one or more computing devices and/or other computer components (e.g., processors, memories, communication interfaces, or the like). For example, the quantum trip wire platform 102 may provide a plurality of services (e.g., for processing various application programming interface (API) information, requests, or the like). In some instances, the quantum trip wire platform 102 may be a system with an expectation for high availability, and may, in some instances, handle an unpredictable volume of requests, information, or the like. In some instances, the quantum trip wire platform 102 may be a quantum computing system configured to execute one or more quantum computing processes. In some instances, the quantum trip wire platform 102 may include trip wire capabilities, as are described further below, which may, e.g., enable the quantum trip wire platform 102 to effectively trip or cut off a flow of incoming requests/information to prevent system overload, outage, or the like. In these instances, the quantum trip wire platform 102 may be configured to dynamically monitor its payload, and to restore the flow of incoming requests/information upon detecting that system conditions are sufficient to resume processing. In doing so, the quantum trip wire platform 102 may effectively toggle between the trip and non-trip modes to prevent system overload, outage, or the like.

API data source 103 may be or include one or more computing devices (e.g., servers, server blades, or the like) and/or computer components (e.g., processors, memories, communication interfaces, and/or other components). API data source 103 may be configured to store and/or otherwise provide API requests/information such as consumer API data, small business API data, merchant API data, payment API data, digital services API data, and/or other data. Although illustrated as a single device, any number of data sources may provide API information without departing from the scope of the disclosure.

Overflow processing system 104 may include one or more computing devices and/or other computer components (e.g., processors, memories, communication interfaces, or the like). In some instances, overflow processing system 104 may be configured to process API requests/information to provide overflow support to the quantum trip wire platform 102. For example, in instances where the quantum trip wire platform 102 activates the trip wire, API information/requests may be routed from the quantum trip wire platform 102 to the overflow processing system 104 for processing instead.

Overflow queuing system 105 may include one or more computing devices and/or other computer components (e.g., processors, memories, communication interfaces, or the like). In some instances, overflow queuing system 105 may be configured to store a queue of API requests/information to provide overflow support to the quantum trip wire platform 102. For example, in instances where the quantum trip wire platform 102 activates the trip wire, API information/requests may be routed from the quantum trip wire platform 102 to the overflow queuing system 105. Then, once the quantum trip wire platform 102 identifies that processing may be resumed, such API requests/information may be routed from the overflow queuing system 105 back to the quantum trip wire platform 102 for processing. In some instances, the overflow queuing system 105 may be implemented in addition or as an alternative to the overflow processing system 104.

Computing environment 100 also may include one or more networks, which may interconnect quantum trip wire platform 102, API data source 103, overflow processing system 104, and overflow queuing system 105. For example, computing environment 100 may include a network 101 (which may interconnect, e.g., quantum trip wire platform 102, API data source 103, overflow processing system 104, and overflow queuing system 105).

In one or more arrangements, quantum trip wire platform 102, API data source 103, overflow processing system 104, and overflow queuing system 105 may be any type of computing device capable of receiving input and communicating the received input to one or more other computing devices. For example, quantum trip wire platform 102, API data source 103, overflow processing system 104, overflow queuing system 105, and/or the other systems included in computing environment 100 may, in some instances, be and/or include server computers, desktop computers, laptop computers, tablet computers, smart phones, or the like that may include one or more processors, memories, communication interfaces, storage devices, and/or other components. As noted above, and as illustrated in greater detail below, any and/or all of quantum trip wire platform 102, API data source 103, overflow processing system 104, overflow queuing system 105 may, in some instances, be special-purpose computing devices configured to perform specific functions.

Referring to FIG. 1B, quantum trip wire platform 102 may include one or more processors 111, memory 112, and communication interface 113. A data bus may interconnect processor 111, memory 112, and communication interface 113. Communication interface 113 may be a network interface configured to support communication between quantum trip wire platform 102 and one or more networks (e.g., network 101, or the like). Memory 112 may include one or more program modules having instructions that when executed by processor 111 cause quantum trip wire platform 102 to perform one or more functions described herein and/or one or more databases that may store and/or otherwise maintain information which may be used by such program modules and/or processor 111. In some instances, the one or more program modules and/or databases may be stored by and/or maintained in different memory units of quantum trip wire platform 102 and/or by different computing devices that may form and/or otherwise make up quantum trip wire platform 102. For example, memory 112 may have, host, store, and/or include quantum trip wire module 112a and quantum trip wire database 112b. Quantum trip wire module 112a may have instructions that direct and/or cause quantum trip wire platform 102 to execute advanced techniques for dynamically tripping processing of incoming information/requests to prevent system outage, and/or perform other actions. Quantum trip wire database 112b may store information used by quantum trip wire module 112a, and/or other modules in dynamically tripping incoming information/requests to prevent system outage, and/or performing other actions.

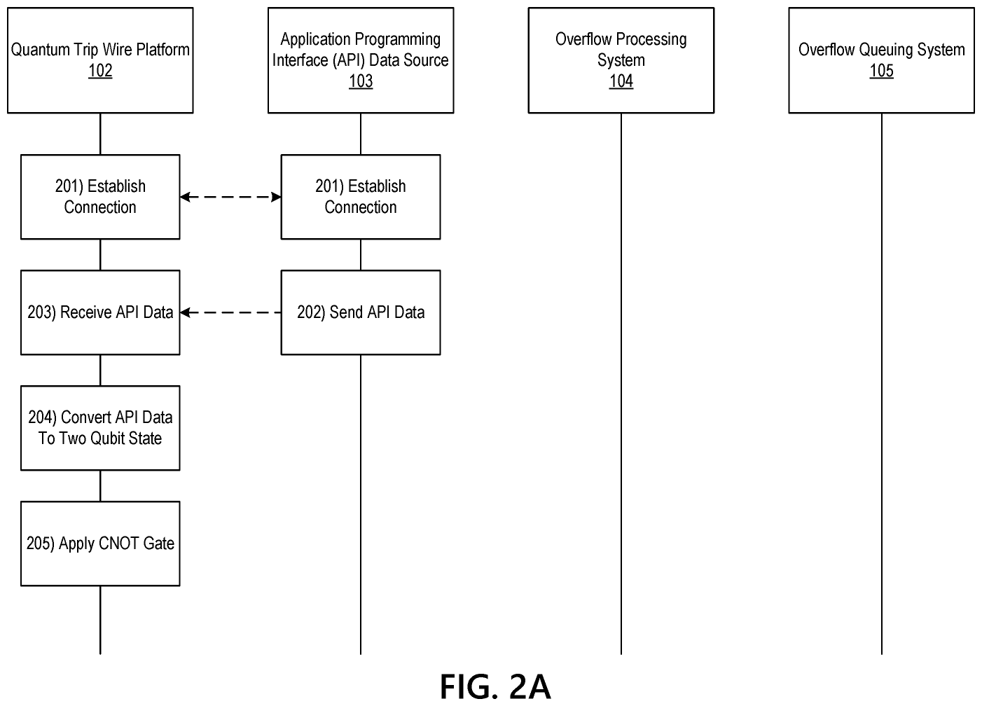

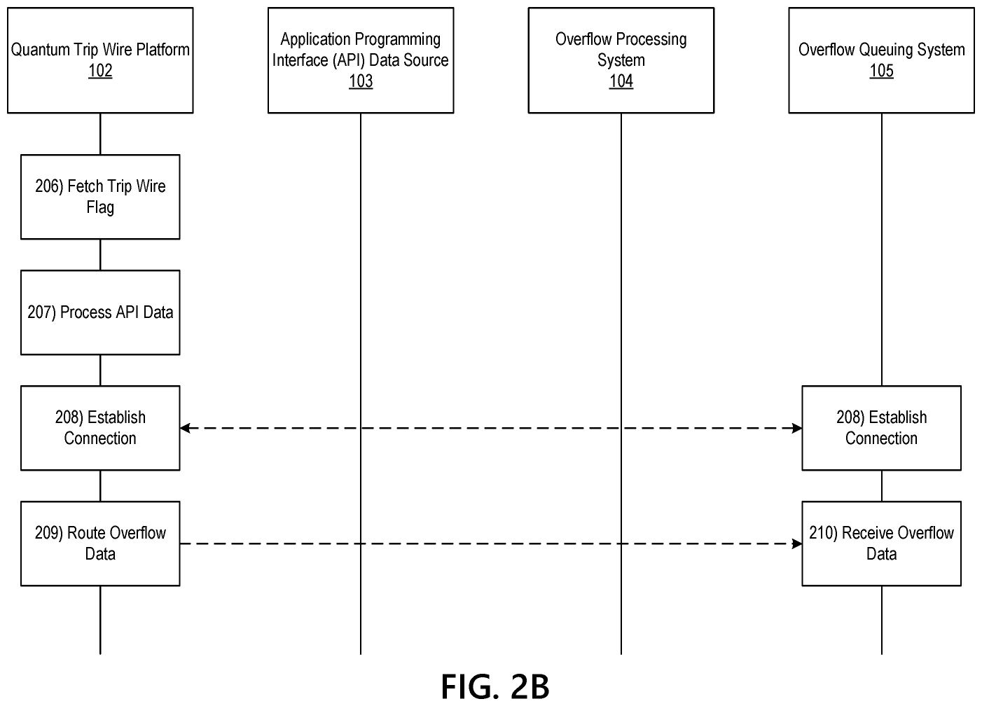

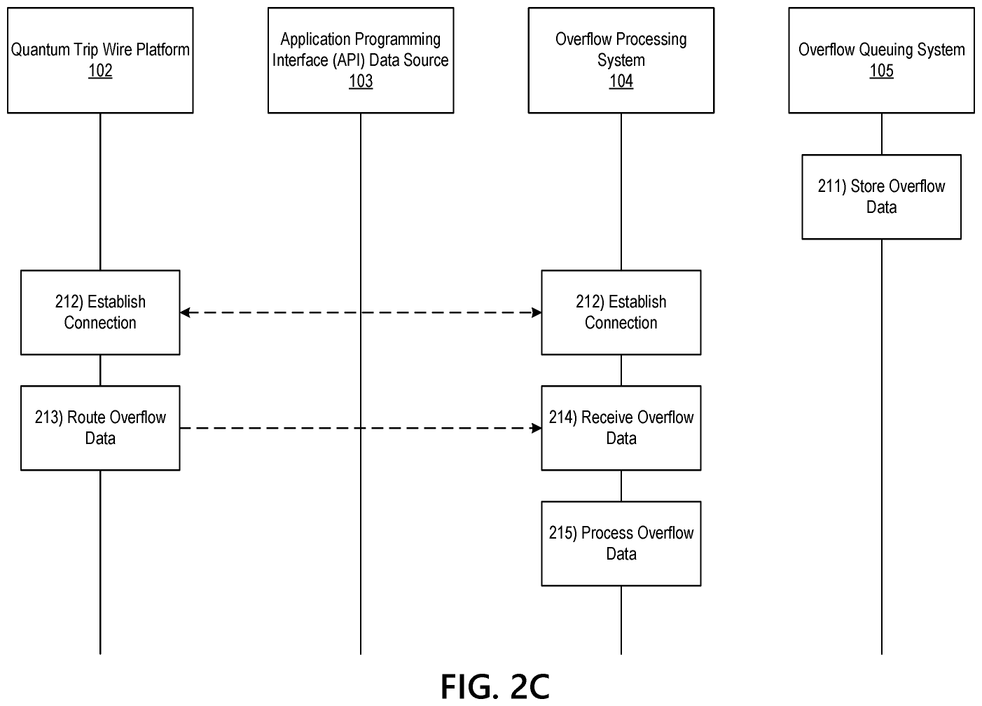

FIGS. 2A-2C depict an illustrative event sequence for dynamically activating a quantum trip wire based on payload vectors in accordance with one or more example embodiments. Referring to FIG. 2A, at step 201, API data source 103 may establish a connection with quantum trip wire platform 102. For example, the API data source 103 may establish a first wireless data connection with the quantum trip wire platform 102 to link the API data source 103 to the quantum trip wire platform 102 (e.g., in preparation for sending API data, requests, information, or the like). In some instances, the API data source 103 may identify whether or not a connection is already established with the quantum trip wire platform 102. If a connection is already established with the quantum trip wire platform 102, the API data source 103 might not re-establish the connection. Otherwise, if a connection is not yet established with the quantum trip wire platform 102, the API data source 103 may establish the first wireless data connection as described herein.

At step 202, API data source 103 may send API data to the quantum trip wire platform 102. For example, the API data source 103 may send the API data while the first wireless data connection is established. In some instances, the API data source 103 may send consumer API data, small business API data, merchant API data, payment API data, digital services API data, and/or other information. Although step 202 depicts sending all API data from a single API data source 103, such data may, in some instances, be sent from a plurality of different API data sources. For example, each of the different types of API data may be sent as different data streams from different API data sources.

At step 203, the quantum trip wire platform 102 may receive the API data sent at step 202. For example, the quantum trip wire platform 102 may receive the API data via the communication interface 113 and while the first wireless data connection is established. As described above, the API data may, in some instances, be received from a plurality of API data sources as a plurality of different data streams.

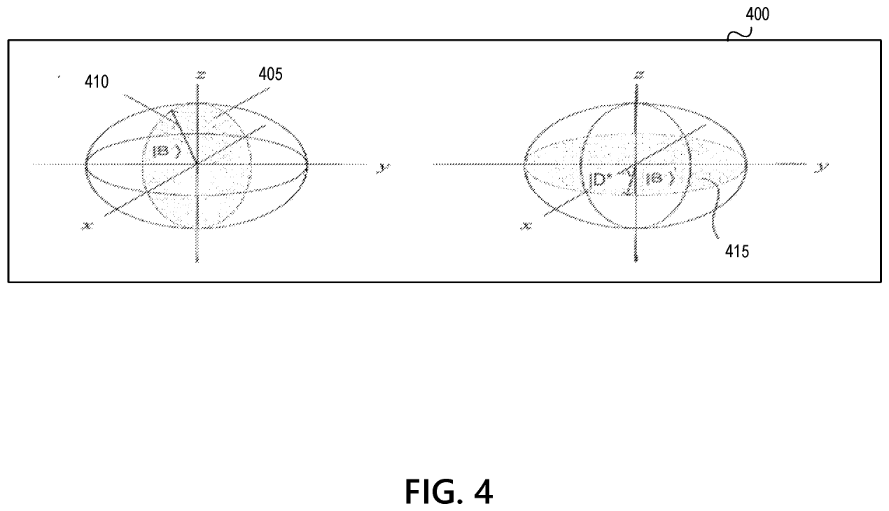

At step 204, the quantum trip wire platform 102 may convert the API data to a two qubit state. For example, upon initially receiving the API data, the quantum trip wire platform 102 may represent the data using data plane 405, which is shown in FIG. 4. For example, the X axis may represent incoming trip wire webservice volume (e.g., the incoming API data), the Y axis may represent a trip wire status (e.g., is the trip wire activated or not), and the Z axis may represent the trip wire flag value (e.g., a value of zero or one). The data plane 405 represents the XZ bloch-sphere trip wire webservice payload processing plane. A state vector |B [symbol] 410 is illustrated lying within this plane. The data plane 415 represents the XY plane within the bloch sphere (e.g., a state space of all possible points to which a state vector may point, which may demonstrate the state of qubit). The vector |B [symbol] 410 in the data plane 405 with bloch-sphere angles θ and φ=0 may be rotated to lie within the XY plane with bloch-sphere angles. For example, |D* [symbol] operator may be applied to the qubit in state |B [symbol] to rotate the qubit into the XY plane (e.g., to transition from the state depicted in data plane 405 to the state depicted in data plane 415).

In some instances, to perform this rotation, the quantum trip wire platform 102 may use a combination of Unitary and Hadamard quantum gates, which may resemble the following operator:

$$\vert {D}^{*} 〉 = \frac{1}{\sqrt{2}} [ \begin{matrix}1 & - i \\ 1 & i\end{matrix} ] .$$

Given a qubit with a state or rotation lying in the XZ plane with a bloch-sphere angle θ,

$$\vert B 〉 = [ \begin{matrix}cos \frac{θ}{2} \\ sin \frac{θ}{2}\end{matrix} ] .$$

The |D* [symbol] operator may be applied to the qubit in state |B [symbol] to rotate the qubit into the XY plane. For example, the quantum trip wire platform 102 may execute the following formula:

$$\vert {D}^{*} 〉 = \frac{1}{\sqrt{2}} [ \begin{matrix}1 & - i \\ 1 & i\end{matrix} ] [ \begin{matrix}cos \frac{θ}{2} \\ sin \frac{θ}{2}\end{matrix} ] = \frac{1}{\sqrt{2}} [ \begin{matrix}1 \\ {e}^{i θ}\end{matrix} ] .$$

By applying this quantum gate, the quantum trip wire platform 102 may take an arbitrary quantum system e that takes, as input, a state |φi and outputs a different state e|φi, where e may be a unitary linear transformation.

In doing so, the quantum trip wire platform 102 may produce a two qubit quantum circuit that rotates the state vector of an input qubit about the Z (e.g., trip wire flag value) axis. The inputs to this quantum circuit may include a first qubit, referred to as the “control qubit,” with a state vector lying in the XY plane (e.g., trip wire status*incoming trip wire webservice volume). The bloch sphere plane may have an angle φ, and this first qubit may be referred to as |Z(φ) [symbol] . A second input qubit, referred to as the “subject cubit”,” may have the arbitrary state |B [symbol] . Together, these inputs may be a two qubit state representative of the API data. In some instances, this two qubit state may be expressed as the tensor product of each single qubit state using the following expression: |Z(φ) [symbol] |B [symbol] =a|00 [symbol] +b|01 [symbol] +ae^{iφ}|10 [symbol] +be^{iφ}|11 [symbol] .

At step 205, the quantum trip wire platform 102 may apply a CNOT gate to the two qubit state. In these instances, when the state of the subject qubit is |0, the state of the control qubit may be unaffected by the CNOT gate. However, when the state of the subject qubit is |1, the state of the control qubit may be inverted, either from |0 to |1, or from |1 to |0. Once the two qubit state passes through the CNOT gate, the resulting state may be: CNOT|Z(φ) [symbol] |B [symbol] =a|00)+b|01 [symbol] +ae^{iφ}|10 [symbol] +be^{iφ}|11 [symbol] , which may, e.g., correspond to a value of zero or one depending on the current state.

Referring to FIG. 2B, at step 206, the quantum trip wire platform 102 may fetch the trip wire flag. For example, activation of the trip wire flag may be based on the trip wire flag value of zero or one output by the CNOT gate at step 205. If the quantum trip wire platform 102 identifies that the trip wire flag value is one (1), it may proceed to step 207. In contrast, if the quantum trip wire platform 102 identifies that the trip wire flag value is zero (0), it may activate the trip wire and proceed to step 208 and/or 212.

Although the above described steps refer to activation of the trip wire flag generally based on the API data, in some instances, the quantum trip wire platform 102 may perform the above described analysis for individual data streams, and may in those instances, be configured to activate/not activate the trip wire flag on a data stream by data stream basis (e.g., activate trip wire for consumer API data but not small business API data, or the like).

By using quantum gates to activate the trip wire flag, the quantum trip wire platform 102 may increase the speed by which the trip wire flag may be activated (which may, e.g., reduce a likelihood of system overload). Additionally, the use of the quantum gates may allow the quantum trip wire platform 102 to effectively trigger the trip wire regardless of the unpredictability of any input data/information, which may, e.g., further reduce a likelihood of system overload (and thus a likelihood of system failure).

At step 207, based on identifying that the trip wire flag is not activated, the quantum trip wire platform 102 may process the API data (e.g., process any requests, store information, and/or perform other functionality). For example, the quantum trip wire platform 102 may process credit card applications, loan applications, electronic trades, digital sales, payments, and/or other information. After processing the API data, the quantum trip wire platform 102 may return to step 203 to receive additional API data.

In some instances, at step 207, if a transition from an activated trip wire flag to a deactivated trip wire flag is detected, if overflow data was being processed by the overflow processing system 104, the quantum trip wire platform 102 may cause any further data to be processed by the quantum trip wire platform 102, so long as the trip wire flag remains deactivated. Similarly, if overflow data was being stored in the overflow queuing system 105, the quantum trip wire platform 102 may send one or more commands directing the overflow queuing system 105 to sequentially route overflow data back to the quantum trip wire platform 102 for processing (which may, e.g., cause the overflow queuing system 105 to route the overflow data back to the quantum trip wire platform 102) for processing.

At step 208, based on identifying that the trip wire has been activated, the quantum trip wire platform 102 may establish a connection with the overflow queuing system 105. For example, the quantum trip wire platform 102 may establish a second wireless data connection with the overflow queuing system 105 to link the quantum trip wire platform 102 to the overflow queuing system 105 (e.g., in preparation for routing overflow data). In some instances, the quantum trip wire platform 102 may identify whether or not a connection is already established with the overflow queuing system 105. If a connection is already established with the overflow queuing system 105, the quantum trip wire platform 102 might not re-establish the connection. If a connection is not yet established with the overflow queuing system 105, the quantum trip wire platform 102 may establish the second wireless data connection as described herein.

At step 209, the quantum trip wire platform 102 may route overflow data (e.g., any API data that has not yet been processed) to the overflow queuing system 105. For example, the quantum trip wire platform 102 may route the overflow data to the overflow queuing system 105 via the communication interface 113 and while the second wireless data connection is established. In doing so, the quantum trip wire platform 102 may route the overflow data away from the quantum trip wire platform 102 to prevent overload on the quantum trip wire platform 102, which may, e.g., cause the quantum trip wire platform 102 to crash, fail, experience outage, and/or otherwise cause forced downtime of the quantum trip wire platform 102.

At step 210, the overflow queuing system 105 may receive the overflow data from the quantum trip wire platform 102. For example, the overflow queuing system 105 may receive the overflow data from the quantum trip wire platform 102 while the second wireless data connection is established.

Referring to FIG. 2C, at step 211, the overflow queuing system 105 may store the overflow data. For example, the overflow queuing system 105 may store the overflow data in a queue, which may, e.g., then be released sequentially for processing by the quantum trip wire platform 102 once the quantum trip wire is de-activated. After step 211, the quantum trip wire platform 102 may return to step 203 to receive additional API, and to continue monitoring the quantum wire trip flag.

In addition or as an alternative to routing the overflow data to the overflow queuing system 105, the quantum trip wire platform 102 may route the overflow data to an overflow processing system (e.g., overflow processing system 104) for alternative processing as described below with regard to steps 212-215.

At step 212, the quantum trip wire platform 102 may establish a connection with the overflow processing system 104. For example, the quantum trip wire platform 102 may establish a third wireless data connection with the overflow processing system 104 to link the quantum trip wire platform 102 to the overflow processing system 104 (e.g., in preparation for routing overflow data for processing). In some instances, the quantum trip wire platform 102 may identify whether or not a connection is already established with the overflow processing system 104. If a connection is already established with the overflow processing system 104, the quantum trip wire platform 102 might not re-establish the connection. If a connection is not yet established with the overflow processing system 104, the quantum trip wire platform 102 may establish the third wireless data connection as described herein.

At step 213, the quantum trip wire platform 102 may route the overflow data to the overflow processing system 104. For example, the quantum trip wire platform 102 may route the overflow data to the overflow processing system 104 via the communication interface 113 and while the third wireless data connection is established. In some instances, the quantum trip wire platform 102 may also send one or more commands directing the overflow processing system 104 to process the overflow data.

At step 214, the overflow processing system 104 may receive the overflow data sent at step 213. For example, the overflow processing system 104 may receive the overflow data while the third wireless data connection is established. In some instances, the overflow processing system 104 may also receive the one or more commands directing the overflow processing system 104 to process the overflow data.

At step 215, based on or in response to the one or more commands directing the overflow processing system 104 to process the overflow data, the overflow processing system 104 may process the overflow data. For example, the overflow processing system 104 may perform actions similar to those described above with regard to the quantum trip wire platform 102 at step 207. After step 215, the quantum trip wire platform 102 may return to step 203 to receive additional API, and to continue monitoring the quantum wire trip flag.

As described above with regard to the quantum trip wire platform 102, in some instances, the trip wire may be activated on a data stream by data stream basis. In these instances, the overflow processing system 104 may, in some instances, process only a particular data stream for which the quantum trip wire has been activated. Similarly, the overflow queuing system 105 may store only a particular data stream for which the quantum trip wire has been activated.

Steps 201-215 represent an illustrative event sequence to demonstrate the systems and methods described herein. However, these steps may, in some instances, occur in a different order, simultaneously, in a loop, and/or otherwise without departing from the scope of the disclosure. For example, the quantum trip wire platform 102 may continuously receive new API data, monitor performance, activate/deactivate the trip wire accordingly. Based on the current state of the trip wire, the quantum trip wire platform 102 may either process API data, or route the API data for storage/alternative processing by an overflow system.

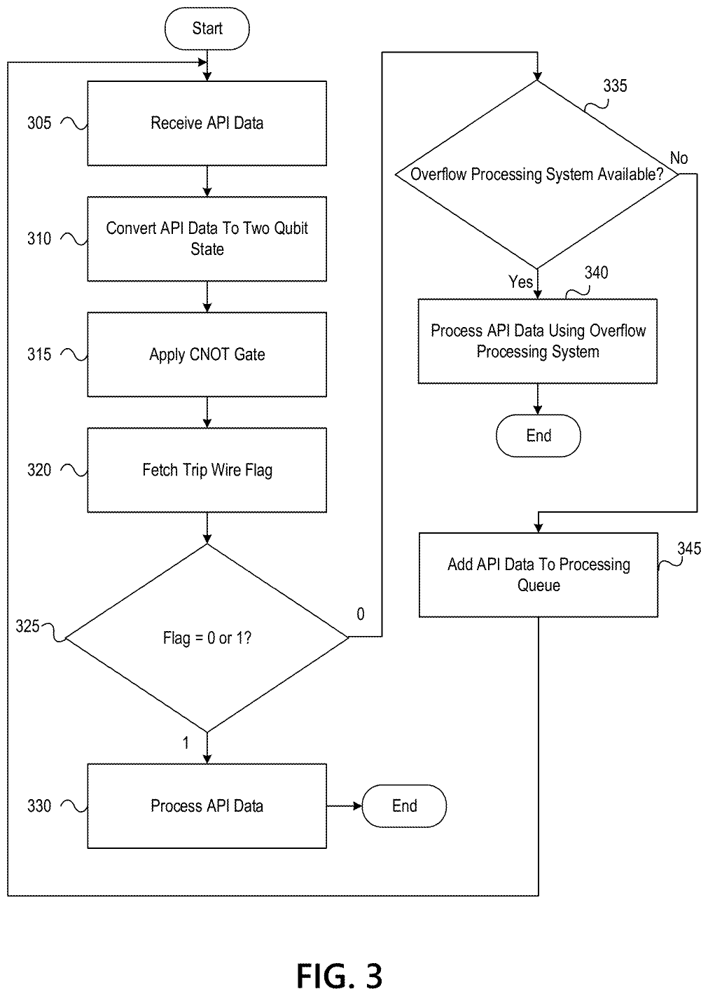

FIG. 3 depicts an illustrative method for dynamically activating a quantum trip wire based on payload vectors in accordance with one or more example embodiments. Referring to FIG. 3, at step 305, a computing platform comprising a memory, one or more processors, and a communication interface may receive API data. At step 310, the computing platform may convert the API data to a two qubit state. At step 315, the computing platform may apply a CNOT gate to the two qubit state to produce a trip wire flag value. At step 320, the computing platform may fetch a trip wire flag based on the trip wire flag value. At step 325, the computing platform may identify whether the trip wire flag corresponds to a value of zero or one. If the trip wire flag corresponds to a value of one, the computing platform may proceed to step 330. At step 330, the computing platform may process the API data.

Returning to step 325, if the computing platform identified that the trip wire flag corresponds to a value of zero, the computing platform may activate the trip wire and proceed to step 335. At step 335, the computing platform may identify whether or not an overflow processing system is available. If an overflow processing system is available, the computing platform may proceed to step 340 to process the API data using the overflow processing system. If an overflow processing system is not available, the computing platform may proceed to step 345 to add API data to a processing queue of an overflow queuing system. The computing platform may continue to monitor the trip wire flag, and may return to step 305 to receive additional API data.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

What is claimed is:

1. A quantum computing platform comprising:
at least one processor;
a communication interface communicatively coupled to the at least one processor; and
memory storing computer-readable instructions that, when executed by the at least one processor, cause the quantum computing platform to:
receive, at the quantum computing platform, application programming interface (API) information;
convert the API information to a two qubit state;
apply, to the converted API information, a controlled-not (CNOT) gate, wherein applying the CNOT gate produces a trip wire flag value of zero (0) or one (1); and
based on identifying a trip wire flag value of zero (0), activate a quantum trip wire, wherein activating the quantum trip wire causes at least a portion of the API information to be routed to an overflow processing system.

2. The quantum computing platform of claim 1, wherein the API information comprises a plurality of different information streams, and wherein activating the quantum trip wire comprises activating, for a single information stream of the plurality of different information streams, the quantum trip wire.

3. The quantum computing platform of claim 1, wherein the API information comprises one or more of: consumer API data, small business API data, merchant API data, payment API data, or digital services API data.

4. The quantum computing platform of claim 1, wherein converting the API information to the two qubit state comprises:
rotating, around a Z axis and using a quantum gate, a state vector representative of:
an incoming trip wire webservice volume corresponding to the API information and represented by an X axis, and
a trip wire status, indicating whether or not the quantum trip wire has been activated, represented by a Y axis, wherein the Z axis is representative of the trip wire flag value.

5. The quantum computing platform of claim 1, wherein the overflow processing system comprises an overflow queuing system, configured to store the portion of the API information.

6. The quantum computing platform of claim 5, wherein the memory stores additional computer readable instructions that, when executed by the at least one processor, cause the quantum computing platform to:
continue monitoring the trip wire flag value; and
based on identifying that the trip wire flag value has changed to one (1), redirect the portion of the API information from the overflow processing system to the quantum computing platform.

7. The quantum computing platform of claim 1, wherein the overflow processing system is configured to process the portion of the API information as an alternative to the quantum computing platform.

8. The quantum computing platform of claim 7, wherein the memory stores additional computer readable instructions that, when executed by the at least one processor, cause the quantum computing platform to:
continue monitoring the trip wire flag value; and
based on identifying that the trip wire flag value has changed to one (1), cease redirection of the portion of the API information to the overflow processing system.

9. The quantum computing platform of claim 1, wherein the memory stores additional computer readable instructions that, when executed by the at least one processor, cause the quantum computing platform to:
based on identifying a value of one (1), process the API information, wherein processing the API information comprises processing one or more requests corresponding to the API information.

10. A method comprising:
at a quantum computing platform comprising at least one processor, a communication interface, and memory:
receiving, at the quantum computing platform, application programming interface (API) information;
converting the API information to a two qubit state;
applying, to the converted API information, a controlled-not (CNOT) gate, wherein applying the CNOT gate produces a trip wire flag value of zero (0) or one (1); and
based on identifying a trip wire flag value of zero (0), activating a quantum trip wire, wherein activating the quantum trip wire causes at least a portion of the API information to be routed to an overflow processing system.

11. The method of claim 10, wherein the API information comprises a plurality of different information streams, and wherein activating the quantum trip wire comprises activating, for a single information stream of the plurality of different information streams, the quantum trip wire.

12. The method of claim 10, wherein the API information comprises one or more of: consumer API data, small business API data, merchant API data, payment API data, or digital services API data.

13. The method of claim 10, wherein converting the API information to the two qubit state comprises:
rotating, around a Z axis and using a quantum gate, a state vector representative of:
an incoming trip wire webservice volume corresponding to the API information and represented by an X axis, and
a trip wire status, indicating whether or not the quantum trip wire has been activated, represented by a Y axis, wherein the Z axis is representative of the trip wire flag value.

14. The method of claim 10, wherein the overflow processing system comprises an overflow queuing system, configured to store the portion of the API information.

15. The method of claim 14, further comprising:
continuing monitoring of the trip wire flag value; and
based on identifying that the trip wire flag value has changed to one (1), redirecting the portion of the API information from the overflow processing system to the quantum computing platform.

16. The method of claim 10, wherein the overflow processing system is configured to process the portion of the API information as an alternative to the quantum computing platform.

17. The method of claim 16, further comprising:
continuing to monitor the trip wire flag value; and
based on identifying that the trip wire flag value has changed to one (1), ceasing redirection of the portion of the API information to the overflow processing system.

18. The method of claim 10, further comprising:
based on identifying a value of one (1), process the API information, wherein processing the API information comprises processing one or more requests corresponding to the API information.

19. One or more non-transitory computer-readable media storing instructions that, when executed by a quantum computing platform comprising at least one processor, a communication interface, and memory, cause the quantum computing platform to:
receive, at the quantum computing platform, application programming interface (API) information;
convert the API information to a two qubit state;
apply, to the converted API information, a controlled-not (CNOT) gate, wherein applying the CNOT gate produces a trip wire flag value of zero (0) or one (1); and
based on identifying a trip wire flag value of zero (0), activate a quantum trip wire, wherein activating the quantum trip wire causes at least a portion of the API information to be routed to an overflow processing system.

20. The one or more non-transitory computer-readable media of claim 19, wherein the API information comprises a plurality of different information streams, and wherein activating the quantum trip wire comprises activating, for a single information stream of the plurality of different information streams, the quantum trip wire.
